(19) United States
(12) Patent Application Publication
(10) Pub. No.: US 2021/0087012 A1
(43) Pub. Date: Mar. 25, 2021

(54) METHODS OF SEALING OF MULTILAYER, MONOLITHIC LAYER AND COMPOSITES OF ETFE AND ITS ALTERNATIVES FOR ROOFING APPLICATIONS

(71) Applicants: Madico, Inc., Pinellas Park, FL (US); SC Innovation, LLC, Houston, TX (US)

(72) Inventors: Marina Temchenko, Pinellas Park, FL (US); Daniel Howes, Pinellas Park, FL (US); Yaroslav Klichko, Pinellas Park, FL (US); Tadahiro Tomino, Pinellas Park, FL (US); Martin Augustyniak, Elma, NY (US); Philip Canale, Pinellas Park, FL (US)

(21) Appl. No.: 17/029,553

(22) Filed: Sep. 23, 2020

Related U.S. Application Data
(60) Provisional application No. 62/903,989, filed on Sep. 23, 2019.

(51) Int. Cl. B65H 35/00; C09J 7/35; B32B 7/12; B32B 27/32; B32B 37/12

(52) U.S. Cl. CPC B65H 35/002; C09J 7/35; B32B 2037/1223; B32B 27/322; B32B 37/1207; B32B 7/12

(57) ABSTRACT

A heat and/or UV/LED activated single or double-sided tape is configured to seal multiple sheets of single or multilayer composite film with the film including an outer fluoropolymer layer. A repair kit includes a single-sided and/or double-sided heat and UV/LED activated adhesive tape, portable surface treater, and portable heat/UV/LED generating device. The single-sided and/or double-sided heat and UV/LED activated adhesive tape is useful in the manufacturing of architectural applications and in repair of architectural applications.

### CROSS-REFERENCE TO RELATED APPLICATION

This patent application claims priority to U.S. Provisional Patent Application Ser. No. 62/903,989, filed on Sep. 23, 2019, the entire disclosure of which is hereby incorporated herein by reference.

### TECHNICAL FIELD

The present disclosure relates generally to polymer roofing materials. Specifically, the present disclosure relates to novel methods of sealing of multilayer composite films and monolithic films for architectural applications, and methods of repairing monolithic and multilayer composite roofing materials on site by using heat activated or ultraviolet (UV) activated tape.

### BACKGROUND

Fluorinated polymers such as ethylene tetrafluoroethylene (ETFE) can be used in some architectural applications in place of conventional architectural glass. This is due, in part, to the light weight, visible light transparency and translucency, UV stability, thermal stability, and flexibility exhibited by ETFE sheets. When used as a roofing material in architectural applications, ETFE is often either configured in a single layer that is supported by a network of cables or as a series of pneumatic cushions formed by joining between two and five layers of ETFE together and inflating a space defined by the joined ETFE layers.

Fabricating and maintaining a pneumatic cushion is currently an industry standard method of using ETFE for architectural elements. ETFE is extruded as a single sheet or a multilayer sheet. ETFE sheets are joined together by a heat sealing process to form an envelope, which is then assembled into an architectural panel by attaching the envelope to a frame made from a structural material (e.g., aluminum, steel). The frame and the attached envelopes are in turn joined to support an architectural structure. The ETFE envelopes are inflated to form the pneumatic cushion. Pressure is maintained within the ETFE pneumatic cushions using a pressurization unit (such as a compressor) that maintains an internal pressure of the ETFE pneumatic cushions at approximately 220 Pa, thus providing structural stability to the pneumatic pillow.

However, such ETFE films have drawbacks that limit their applicability to certain architectural applications. One drawback of ETFE films is a susceptibility to damage by cutting and puncture following installation of the ETFE films. For example, pecking by birds or impact from airborne debris can cause punctures and tears within the thin films.

Currently, repair of created holes on the site of the architectural elements is a temporary solution which is based on application of adhesive tapes which provide poor adhesion and therefore need to be replaced frequently. The use of such temporary adhesive tapes also does not allow for subpanel replacement, so the aforementioned problems persist following the attempt to repair the subpanel.

There accordingly exists a need for an improved method of sealing such films or repairing tears or penetrations within such films, and especially a method of making permanent repairs to cuts and punctured holes within such films or permanently repairing or replacing subpanels within a larger roof or façade main panel.

### SUMMARY

In one embodiment the present invention, a film assembly for use in architectural applications includes a first film having a first layer formed from a fluorinated polymer and a tape including a backing layer formed from a fluorinated polymer and a first adhesive layer disposed on a first major surface of the backing layer. The first adhesive layer is configured to adhere to the first layer of the first film.

A method of joining components in architectural applications according to the present invention is also disclosed. The method includes the steps of providing a first film having a first layer formed from a fluorinated polymer; providing a tape including a backing layer formed from a fluorinated polymer and a first adhesive layer disposed on a first major surface of the backing layer; and adhering the first adhesive layer of the tape to the first layer of the first film.

A repair kit for use in architectural applications is also disclosed according to an embodiment of the present invention. The repair kit includes a tape including a backing layer formed from a fluorinated polymer and a first adhesive layer disposed on a first major surface of the backing layer, an activating device configured to activate an adhesive forming the first adhesive layer of the tape, and a treating device configured to treat a surface to which the first adhesive layer is configured to be adhered.

### BRIEF DESCRIPTION OF THE DRAWINGS

The above-mentioned, and other features and objects of the invention, and the manner of attaining them will become more apparent and the invention itself will be better understood by reference to the following description of the embodiments of the invention taken in conjunction with the accompanying drawings, wherein:

FIG. 1 is an elevational view of a multilayer composite film according to an embodiment of the present invention;

FIG. 2 is an elevational view of a single-sided tape according to an embodiment of the present invention;

FIG. 3 is an elevational view of a double-sided tape according to an embodiment of the present invention;

FIG. 4 is an elevational view of an assembly including the multilayer composite film of FIG. 1 and the single-sided tape of FIG. 2;

FIG. 5 is an elevational view of an assembly including a single layered film and the single-sided tape of FIG. 2;

FIG. 6 is an elevational view of an assembly including a pair of the multilayer composite films of FIG. 1 configured for coupling to each other via an intervening double-sided tape as disclosed in FIG. 3;

FIG. 7 is an elevational view of an assembly including a pair of the single layered films of FIG. 5 configured for coupling to each other via an intervening double-sided tape as disclosed in FIG. 3;

FIGS. 8 and 9 are elevational views of butt joints formed between adjacent films using the single-sided tape as disclosed in FIG. 2;

FIGS. 10 and 11 are elevational views of lap joints formed between adjacent films using the double-sided tape as disclosed in FIG. 3;

FIGS. 12 and 13 are elevational views of cord edge configurations formed using the double-sided tape as disclosed in FIG. 3;

FIGS. 14 and 15 are elevational views of cord edge configurations formed using the single-sided tape as disclosed in FIG. 2; and

FIG. 16 is a schematic representation of a repair kit according to another embodiment of the present invention.

### DETAILED DESCRIPTION OF THE INVENTION

The present invention relates to adhesive tapes used in joining and repairing films formed from fluorinated polymers or multilayer composite films comprising fluorinated polymers, wherein such films or composite films may be utilized for architectural applications such as roofing applications. Such adhesive tapes may include a backing formed from a fluorinated polymer, wherein the selected fluorinated polymer may be matched to the fluorinated polymer utilized in the corresponding film or composite film adhered to the adhesive tape. The present invention further relates to methods of utilizing such adhesives and adhesive tapes for joining or repairing such films and composite films. These methods may also be utilized to facilitate the replacement of certain panels or subpanels of a larger architectural structure such as a roof or façade main panel. The adhesive used in forming such tapes may be an ultraviolet (UV) activated adhesive, which may be activated by an associated light emitting diode (LED). Hereinafter, such light activated adhesives are referred to as UV/LED activated adhesives. The adhesive may alternatively be a heat activated adhesive or a pressure sensitive adhesive (PSA).

The fluorinated polymer used in forming the backing of the tape or the different layers of any corresponding film or multilayer composite film may be the previously described ETFE or ethylene chlorotrifluoroethylene (ECTFE), each of which is a fluorinated polymer commonly used in architectural applications such as roofing or the like. However, the present invention may be applicable to other fluorinated polymers or weatherable flame retardant polymers suitable for such architectural applications or similar applications. For example, other polymers that may be substituted for the ETFE or ECTFE as commonly described hereinafter may include, but are not limited to polyvinyl fluoride (PVF), polyvinylidene fluoride (PVDF), polychlorotrifluoroethylene (PCTFE), and polyfluoroethylenepropropylene (FEP), ethylene tetrafluoroethylene (ETFE), or perfluoroalkoxy alkane (PFA), among others.

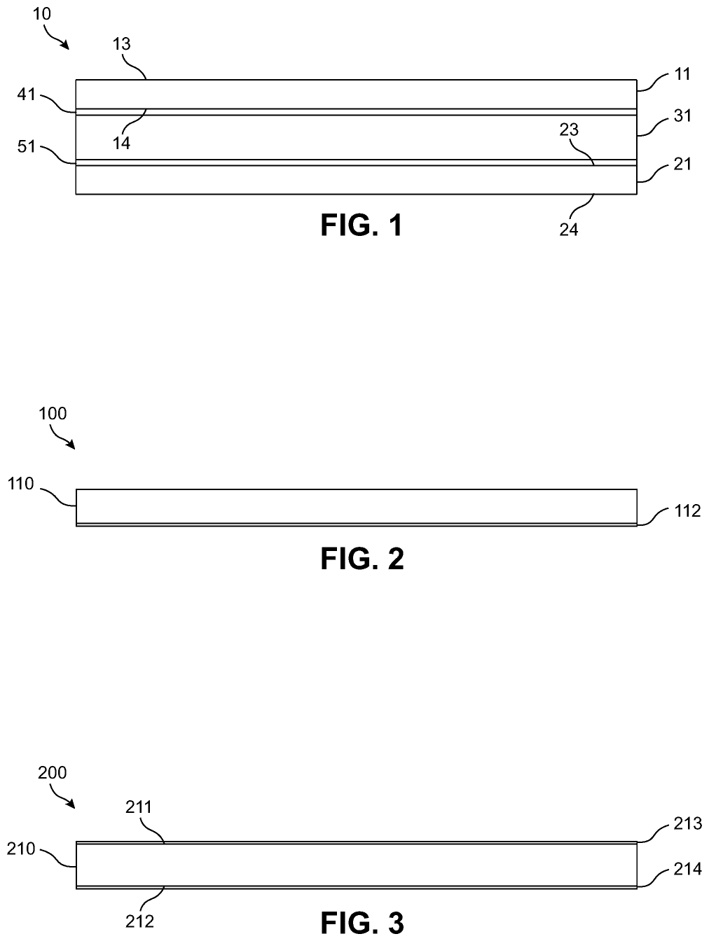

FIG. 1 illustrates an exemplary multilayer composite film 10 that may be joined, repaired, or replaced using an adhesive tape according to the methods of the present invention. The composite film 10 includes a first fluorinated polymer layer 11, a second fluorinated polymer layer 21, and a structural polymer layer 31 disposed between the first fluorinated polymer layer 11 and the second fluorinated polymer layer 21. Although the first and second fluorinated polymer layers 11, 21 are illustrated in the given example as single layers of a sheet of fluorinated polymer, each of the disclosed layers 11, 21 may instead be replaced with multiple layers or sheets of a given fluorinated polymer to form the outwardly facing portions of the multilayer composite film 10 while remaining within the scope of the present invention. For example, each fluorinated polymer layer 11, 21 may be representative of two, three, or more layers/sheets of one or more selected fluorinated polymers.

The first fluorinated polymer layer 11 and the second fluorinated polymer layer 21 may each have a thickness between 25 and 125 microns. The structural polymer layer 31 may have a thickness between 50 and 250 microns. However, these ranges are non-limiting, as the methods and structures according to the present invention may be utilized for different thicknesses of the multilayer composite film 10 and its constituent layers 11, 21, 31 without necessarily departing from the scope of the present invention.

Each of the fluorinated polymer layers 11, 21 may be formed from the same polymer or each of the fluorinated polymer layers 11, 21 may be formed from different polymers, as desired. The fluorinated polymer chosen for the layers 11, 21 may typically be ETFE or ECTFE as are commonly used in architectural applications, although the other listed alternatives may also be utilized while remaining within the scope of the present invention.

The first fluorinated polymer layer 11 includes a first major surface 13 facing outwardly away from the structural polymer layer 31 and a second major surface 14 disposed opposite the first major surface 13 and facing inwardly towards the structural polymer layer 31. The first fluorinated polymer layer may be disposed as an exterior-facing surface of the multilayer composite film 10. For example, the first major surface 13 of the first fluorinated polymer layer 11 may be selected to form an exterior surface (i.e., exposed to the earth's atmosphere) of an architectural application. Placing the first fluorinated polymer layer 11 at an exterior surface may allow for many of the beneficial properties of first fluorinated polymer layer 11 to be employed that may otherwise be lacking in more conventional architectural materials. For example, assuming the first fluorinated polymer layer 11 is formed from ETFE, the low surface energy of ETFE helps shed water and resist accumulation of atmospherically born contaminants (e.g., soot, dirt, dust, pollen). ETFE and other related fluorinated polymers can also exhibit resistance to solvation or other chemical degradation caused by atmospherically borne contaminants and chemicals intentionally applied (e.g., cleaners, detergents) and unintentionally applied (e.g., a spill) to an exterior surface of an architectural application. This low surface energy improves the longevity of the multilayer composite film 10 because the film can resist chemically induced degradation. Furthermore, ETFE transmits as much as 90% or 95% of the intensity of incident visible light (e.g., radiation between wavelengths of 400 nanometers (nm) and 700 nm). This high transmissivity of ETFE is appealing in many architectural applications in which natural light is desired. ECTFE may also be employed for the first fluorinated polymer layer 11 to utilize many of these same beneficial properties.

The second fluorinated polymer layer 21 similarly includes a first major surface 23 and an oppositely arranged second major surface 24. The first major surface 23 faces towards the structural polymer layer 31 while the second major surface 24 faces away from the structural polymer layer 31.

The second fluorinated polymer layer 21 may be selected to form an interior surface of the corresponding architectural element. Alternatively, the second fluorinated polymer layer 21 may be selected to face towards and ultimately be joined to another fluorinated polymer layer of an adjacent and separately provided sheet of the multilayer composite film 10 or another sheet of an individually provided layer of fluorinated polymer forming a film, as desired, without departing from the scope of the present invention. The second fluorinated polymer layer 21 may be selected to employ the same beneficial features as described above regarding the first fluorinated polymer layer 11. The second fluorinated polymer layer 21 may be selected to be ETFE, ECTFE, any of the other listed fluorinated polymers, or any other suitable fluorinated polymer in addition to those listed herein without departing from the scope of the present invention.

The structural polymer layer 31 may be selected to add structural integrity (e.g., higher Young's modulus, flexural modulus, ultimate tensile strength) to the multilayer composite film 10 without compromising the benefits of the outer disposed fluorinated polymer layers 11, 21 described above with respect to the exemplary ETFE or ECTFE. The polymer selected for use as the structural polymer layer 31 may be selected so as not to substantially decrease the transparency, translucence, or clarity of the outer disposed fluorinated polymer layers 11, 21 while at the same time improving the structural properties of the multilayer composite film 10 in the manner discussed above. The structural polymer layer 31 can exhibit a desired degree of visible light transmittance and a desired degree of haze.

One example of a polymer used for the structural polymer layer 31 is polyethylene terephthalate (PET). However, polymers other than PET can be used for the structural polymer layer 31. Alternatives to PET may include, but are not limited to: polypropylene, polyethylene, polyethylene vinyl acetate, polycarbonates, cellulose and cellulose derivatives, polyamide-imide, polyurethanes, polyacrylates, polymethacrylates, polythiophenes, poly(3,4-ethylenedioxythiophene)/polystyrene sulfonate, polystyrene, biopolymers, fluoropolymers, chlorofluoropolymers, vinylfluoropolymers, poly (vinyl chloride), polyethers, polyimides, polyetherimides, polyphenylsulfone, and combinations thereof.

The first fluorinated polymer layer 11 may be coupled to the structural polymer layer 31 using a first adhesive layer 41. Similarly, the second fluorinated polymer layer 21 may be coupled to the structural polymer layer 31 using a second adhesive 51. More specifically, the first adhesive layer 41 may be disposed between the second major surface 14 of the first fluorinated polymer layer 11 and the structural polymer layer 31 while the second adhesive layer 51 may be disposed between the first major surface 23 of the second fluorinated polymer layer 21 and the structural polymer layer 31.

The adhesive layers 41, 51 of the multilayer composite film 10 may be a fluoropolymer adhesive that has high thermal stability, hydrolysis resistance, and UV stability. These properties facilitate long term adhesion between the structural polymer layer 31 and the fluorinated polymer layers 11, 21 even when subjected to months and years of solar-induced heating and solar irradiation, respectively. Furthermore, the strength of adhesion between the structural polymer layer 31 and the fluorinated polymer layers 11, 21 may be selected to be suitable for the given application such as the described architectural application.

An optional IR radiation rejection layer (not shown) of the multilayer composite film 10 may actually include one or both of IR reflecting materials and IR absorbing materials. The IR radiation rejection layer may be configured to reduce the amount of IR radiation passing through the multilayer composite film 10, thus reducing the IR-induced heating of the interior spaces within an architectural structure. Similarly, IR absorbing materials absorb infrared radiation in the film composite and prevent much of the incident IR radiation from reaching the interior of the structure. This in turn reduces the cooling needed for these interior spaces, improving the economic and ecological performance of the architectural structure using the multilayer composite film 10. The IR radiation rejection layer or layers may be disposed adjacent either of the adhesive layers 41, 51 or may be disposed as an outermost layer of the multilayer composite film 10, such as being disposed on the first major surface 13 of the first fluorinated polymer layer 11 or the second major surface 24 of the second fluorinated polymer layer 21.

The multilayer composite film 10 according to the present invention may also be provided devoid of one of the disclosed fluorinated polymer layers 11, 21. As such, the multilayer composite film 10 may include only one of the fluorinated polymer layers 11, 21, the structural polymer layer 31, and one corresponding adhesive layer 41, 51 for joining the single fluorinated polymer layer 11, 21 and the structural polymer layer 31 as described herein.

One exemplary multilayer composite film 10 applicable to the present invention may include the first fluorinated polymer layer 11 formed from ETFE, the second fluorinated polymer layer 21 formed from ETFE, and the structural polymer layer 31 formed from PET. Another exemplary multilayer composite film 10 may include the first fluorinated polymer layer 11 formed from ECTFE, the second fluorinated polymer layer 21 formed from ECTFE, and the structural polymer layer 31 formed from PET. However, any combination of the previously described options for the different layers 11, 21, 31 may be used in combination while remaining within the scope of the present invention.

In addition to the multilayer composite film 10 disclosed herein having the structural polymer layer 31 and at least one fluorinated polymer layer 11, 21, the methods and structures according to the present invention may also be applied to any type of suitable film having only one type of polymer layer. For example, a film 80 formed exclusively from ETFE, ECTFE, or any of the other listed fluorinated polymers or weatherable flame retardant polymers described as suitable for forming one of the fluorinated polymer layers 11, 21 may be substituted for the multilayer composite film 10 as shown throughout the associated drawing figures. Such films 80 are illustrated throughout as having a single layer of the associated fluorinated polymer, but it should be understood that the films 80 may be representative of multiple different layers or sheets of the same fluorinated polymer joined together to a desired thickness. Such films 80 may be utilized in the same architectural applications described as being suitable for use with the multilayer composite films 10 as described herein, although the described advantages of combining two different types of polymers with different characteristics into a single composite film are not appreciated in such circumstances.

Referring now to FIG. 2, a single-sided tape 100 according to an embodiment of the present invention is disclosed. The single-sided tape 100 includes a backing layer 110 and an adhesive layer 112 disposed on a major surface of the backing layer 110. Although not pictured, the single-sided tape 100 may further include a release liner disposed over the adhesive layer 112 to prevent premature adhesion of the adhesive layer 112 to an undesired surface. The backing layer 110 may be formed from a fluorinated polymer or other weatherable flame retardant polymer. The fluorinated polymer or weatherable flame retardant polymer may be ETFE, ETCFE, or any of the other polymers described above as being suitable for forming the fluorinated polymer layers 11, 21 of the multilayer composite film 10 or the layer or layers of the film 80. The fluorinated polymer selected to form the backing layer 110 may be selected to match the outwardly facing fluorinated polymer forming one or both of the fluorinated polymer layers 11, 21 or the film 80. However, the backing layer 110 does not necessarily have to match the adjoining fluorinated polymer layer 11, 21 of the multilayer composite film 10 or the film 80 so long as the adhesive layer 112 is capable of forming the desired bond therebetween as explained hereinafter.

FIG. 3 illustrates a double-sided tape 200 according to another embodiment of the present invention. The double-sided tape 200 includes a backing layer 210 having a first major surface 211 and an opposing second major surface 212. A first adhesive layer 213 is disposed on the first major surface 211 and a second adhesive layer 214 is disposed on the second major surface 212. Although not pictured, the double-sided tape 200 may further include a release liner disposed over each of the adhesive layers 213, 214 to prevent premature adhesion of the adhesive layers 213, 214 to undesired surfaces. The backing layer 210 may be formed from any of the materials described as being suitable for forming the backing layer 110 hereinabove with respect to the single-sided tape 100.

In embodiments of the present invention, the adhesive layer 112 of the single-sided tape 100 or the adhesive layers 213, 214 of the double-sided tape 200 may be formed from a heat activated adhesive. The heat activated adhesive can be formulated as thermoset or thermoplastic. The thermoset adhesive may be comprised of aliphatic polyol and blocked aliphatic isocyanate. The thermoplastic heat activated adhesive may be formulated from polyurethanes, nylon, polyesters, vinyl, and others.

An example of heat activated adhesive used in the invention is Bostik® LADH-7060 TM adhesive. It should be appreciated that other components for heat activated adhesives can be used in the present invention. Examples of the components to be used in heat activated adhesives include but are not limited to: Lumiflon® (Asahi Glass), Zeffle® (Daikin), Zendura® C100 (Honeywell), DESMODUR BL 3370 MPA (Covestro), DESMODUR BL 3475 BA/SN (Covestro), DESMODUR PL 350 MPA/SN (Covestro), DESMODUR PL340 BA/SN (Covestro), DESMODUR 3300 (Covestro), DESMODUR 3800 (Covestro), Impranil® ELH-A (Covestro), Silmer OHT (Siltech), Silmer NH (Siltech), Silmer NCO (Siltech), Silmer ACR (Siltech), Silmer OH ACR (Siltech), Silmer EP (Siltech), Terathane (Terathane) and their combinations.

Exemplary formulations of heat activated adhesives are disclosed hereinbelow in Table 1.

TABLE 1

| Formulation No. | Component Name | Weight (grams) |
|---|---|---|
| 1 | LADH-7060 TM | 207 |
| | MEK | 48 |
| | Toluene | 67 |
| 2 | LADH-7060 TM | 207 |
| | Lumiflon LF 200 | 260 |
| | DESMODUR BL 3370 MPA | 50 |
| | MEK | 48 |
| | Toluene | 67 |
| 3 | Lumiflon LF 200 | 4.94 |
| | Terathane 1000 | 1.11 |
| | DESMODUR PL350 | 3.95 |
| | MEK | 2 |
| 4 | Lumiflon LF 200 | 4.94 |
| | Terathane 1000 | 1.11 |
| | Silmer OHT Di-10 | 1.75 |
| | DESMODUR PL350 | 6.53 |
| | MEK | 2 |
| 5 | Silmer OHT Di-10 | 70 |
| | DESMODUR PL350 | 80 |
| 6 | Lumiflon LF 200 | 100 |
| | DESMODUR N 3800 | 11 |
| | MEK | 20 |
| 7 | Lumiflon LF 200 | 100 |
| | DESMODUR N 3800 | 5 |
| | DESMODUR BL 3370 MPA | 11 |
| | MEK | 20 |
| 8 | TOYO INK “PAT1” | — |
| | Butyl acrylate | 45 |
| | 2Ethyl hexyl acrylate | 50 |
| | Acrylic acid | 5 |

The heat activated adhesives may be activated by positioning a portable heat generating device adjacent the junction between the associated tape 100, 200 and the film 10 or films 10. The heat generating device may be a convective heater, a conductive heater, an infrared heater, or any other suitable heat generating device capable of transferring heat energy to the joint formed between the corresponding combination of one of the tapes 100, 200 and one of the films 10, 80. The heat generating device may preferably be provided as portable to facilitate on-site repair or replacement of the corresponding films 10, 80 using the disclosed tapes 100, 200, such as when damage has occurred to an architectural installation. The use of heat to activate the corresponding adhesive may be advantageous as a relatively low pressure (including no pressure in some circumstances) needs to be applied at the junction between the tape 100, 200 and the film 10, 80 during the heating process. Additionally, the heat is capable of conducting through multiple layers of the adjoining tapes 100, 200 and films 10, 80 to allow for adhesion to take place with respect to covered or buried surfaces as may be present when the tapes 100, 200 and films 10, 80 are layered upon one another.

In other embodiments of the present invention, the adhesive layer 112 of the single-sided tape 100 or the adhesive layers 213, 214 of the double-sided tape 200 may be formed from a UV/LED activated (curable) adhesive. The UV/LED activated adhesive may be selected to react to certain desired range of wavelengths of electromagnetic radiation to cause a photochemical reaction for generating a crosslinked network of polymers.

The UV/LED activated adhesive may be activated (cured) via use of a UV/LED generating device such as a UV light or an LED array, wherein the UV light or the LED array may be configured to generate electromagnetic waves within a specified range of frequencies suitable for causing the activation of the selected UV/LED activated adhesive. The UV/LED generating device may preferably be provided as portable to facilitate on-site repair or replacement of the corresponding films 10, 80 using the disclosed tapes 100, 200, such as when damage has occurred to an architectural installation. The UV/LED activated adhesives may be especially well suited for the fluorinated polymers listed as suitable for forming the tapes 100, 200 and the films 10, 80 disclosed herein due to the relatively high light transmittance through such materials, thereby allowing for the UV/LED activated adhesives to be activated regardless of the presence of an intervening layer of one of the described fluorinated polymer layers between the UV/LED generating device and the corresponding adhesive layer.

In still other embodiments of the invention, the adhesive layer 112 of the single-sided tape 100 or the adhesive layers 213, 214 of the double-sided tape 200 may be formed from a pressure sensitive adhesive. However, such pressure sensitive adhesives may not appreciate the benefits described herein regarding the heat activated adhesives or UV/LED activated adhesives.

The adhesive layers 112, 213, 214 may be applied to the corresponding backing layers 110, 210 by any of a variety of methods known to those skilled in the art of film coating manufacture. Suitable application methods include application by Meyer rod coating, comma coating, spraying, slot die coating, curtain coating, dipping, and/or brushing.

The adhesive layers 112, 213, 214 of the tapes 100, 200 may be selected to have a thickness between 1 μm and 100 μm. The backing layers 110, 210 may each be selected to have a thickness substantially equal to the thickness of the film 10, 80 to which the corresponding tape 100, 200 is applied. However, alternative thicknesses, including a non-matching thickness between the backing layers 110, 210 and the adjoining films 10, 80, may also be utilized without departing from the scope of the present invention.

The composition of each of the described adhesives may also be selected to properties desirable for use in the architectural applications described herein, including being optically clear, flame retardant (VTM-0), moisture resistant, and UV resistant. The adhesive layers 112, 213, 214 should also be selected to have a suitable structural shear resistance to prevent tearing or disjoining of the tapes 100, 200 following application to the films 10, 80.

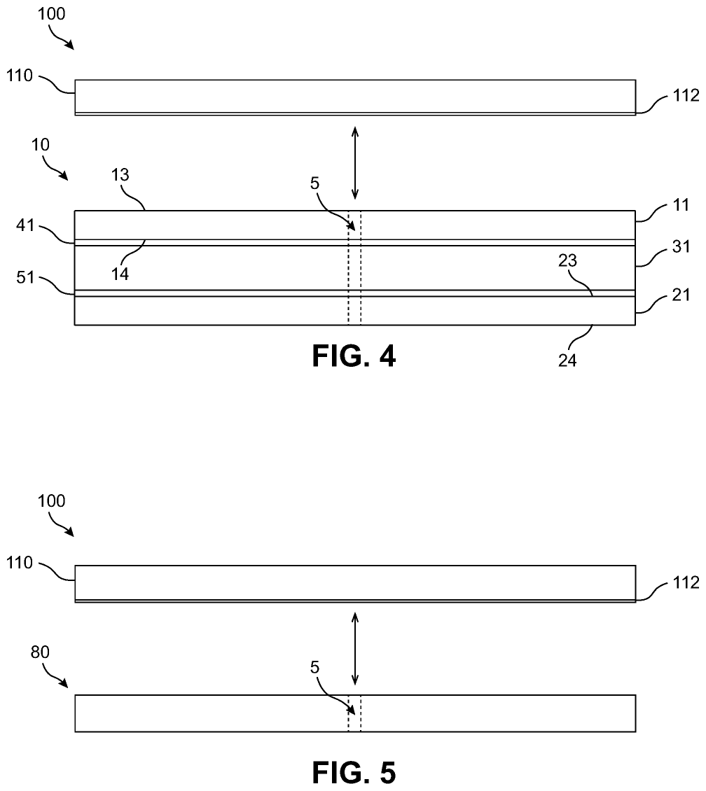

FIGS. 4-15 illustrate various exemplary configurations of the tapes 100, 200 relative to the films 10, 80 for joining, repairing, and replacing the films 10, 80 in accordance with the methods of the present invention. Each of the processes disclosed herein forms a fluid tight seal where the corresponding tape 100, 200 and film 10, 80 or films 10, 80 are joined to one another. However, it should be apparent that the illustrated configurations are not limiting, as the films 10, 80 may be arranged relative to each other in a variety of different configurations suitable for applying the tapes 100, 200 in ways similar to those illustrated. Materials to be joined, repaired, or replaced via use of one of the tapes 100, 200 include but not limited to: fluoropolymeric materials such as ETFE, ECTFE, PVF, PVDF, PVDF coated materials, FEP, PFA, PTFE, PTFE coated materials, PVC, TPO, PMMA, acrylic coatings, silicone coatings, and others. The different joining methods and joints disclosed hereinafter enable individual sheets of the films 10, 80 of the present disclosure to be joined together into a larger architectural panel. For example, individual sheets can be joined together to produce an architectural panel that is anywhere from 1 m to 15 m before requiring external support (such as from a network of support cables or structural steel or concrete).

FIG. 4 shows an application of the single-sided tape 100 onto a multilayer composite film 10. Specifically, the adhesive layer 112 of the single-sided tape 100 is applied to the outwardly facing first major surface 13 of the first fluorinated polymer layer 11 of the multilayer composite film 10. The adhesive layer 112 may be formed from any of the different types of adhesives described herein, and may accordingly be activated (cured) using any of the methods disclosed herein, such as application of heat or UV/LED light thereto. The single-sided tape 100 is accordingly securely joined to the multilayer composite film 10. The backing layer 110 and the first fluorinated polymer layer 11 may be formed from a common material, such as ETFE or ECTFE. However, any of the materials listed herein as suitable for forming the backing layer 110 or either of the fluorinated polymer layers 11, 21 may be used, including combinations of differing materials.

The application of the single-sided tape 100 onto the exposed surface of the multilayer composite film 10 may be representative of a process used to cover and seal around a tear or puncture introduced through the multilayer composite film 10. For example, FIG. 4 further illustrates a tear or puncture 5 formed through the multilayer composite film 10 in broken line form. The single-sided tape 100 may accordingly be applied over the location of the tear or puncture 5 to seal around the tear or puncture 5, thereby repairing the corresponding panel or subpanel formed by the multilayer composite film 10 as may be present in an architectural application. The selection of the backing layer 110 and the outwardly disposed first fluorinated polymer layer 11 as a common material, such as ETFE or ECTFE, thereby aids in maintaining a consistent visual appearance of the joined tape 100 and film 10 while also maintaining substantially similar characteristics of the combination adjacent the joint formed therebetween.

FIG. 5 is substantially similar to FIG. 4 except the multilayer composite film 10 is replaced with the previously described film 80 formed from only one layer or multiple layers of the same material, such as ETFE or ECTFE. It is therefore beneficial to utilize the same material in forming the backing layer 110 as is present in the corresponding film 80 to minimize the appearance or disparity in characteristics between the tape 100 and the film 80. The adhesive layer 112 may once again be formed from any of the different types of adhesives described herein, and may accordingly be activated (cured) using any of the methods disclosed herein, such as application of heat or UV/LED light thereto.

FIG. 5 similarly shows the tape 100 as being disposed over a potential tear or puncture 5 as one possible method of repairing a panel or subpanel formed by the film 80 such as may be present in an architectural application. The backing layer 110 and the film 80 may be selected to include substantially similar or identical thicknesses to maintain the appearance and characteristics of the repaired film 80 following application of the tape 100.

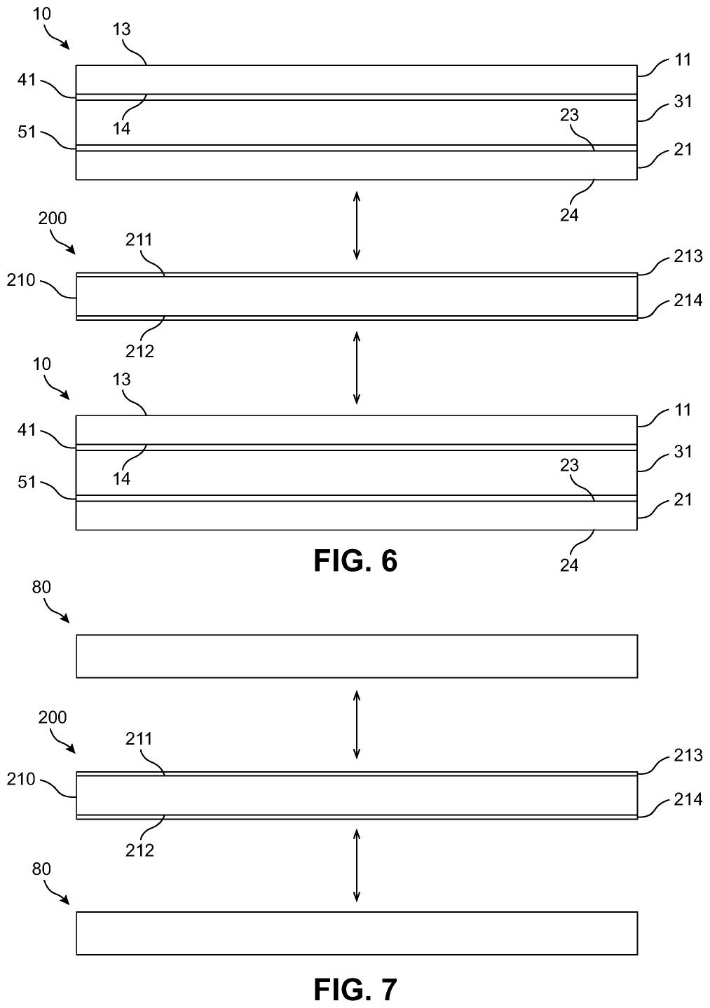

FIGS. 6 and 7 illustrated methods of utilizing the double-sided tape 200 to join together two separate ones of the films 10, 80 to each other. In each case, the adhesive layers 213, 214 may be formed from any of the different types of adhesives described herein and may accordingly be activated (cured) using the correspondingly described methods.

FIG. 6 illustrates the double-sided tape 200 as being disposed between the second major surface 24 of the second fluorinated polymer layer 21 of a first one of the multilayer composite films 10 and the first major surface 13 of the first fluorinated polymer layer 11 of a second one of the multilayer composite films 10. The first adhesive layer 211 is accordingly positioned to adhere to the second major surface 24 of the first one of the multilayer composite films 10 while the second adhesive layer 212 is positioned to adhere to the first major surface 13 of the second one of the multilayer composite films 10. The tape 200 is accordingly configured to join the two multilayer composite films 10 to one another in the illustrated configuration.

FIG. 7 illustrates the double-sided tape 200 as being disposed between a major surface of a first one of the films 80 and a major surface of a second one of the films 80. The first adhesive layer 211 is accordingly positioned to adhere to the facing major surface of the first one of the films 80 while the second adhesive layer 212 is positioned to adhere to the facing major surface of the second one of the films 80. The tape 200 is accordingly configured to join the two films 80 to one another in the illustrated configuration.

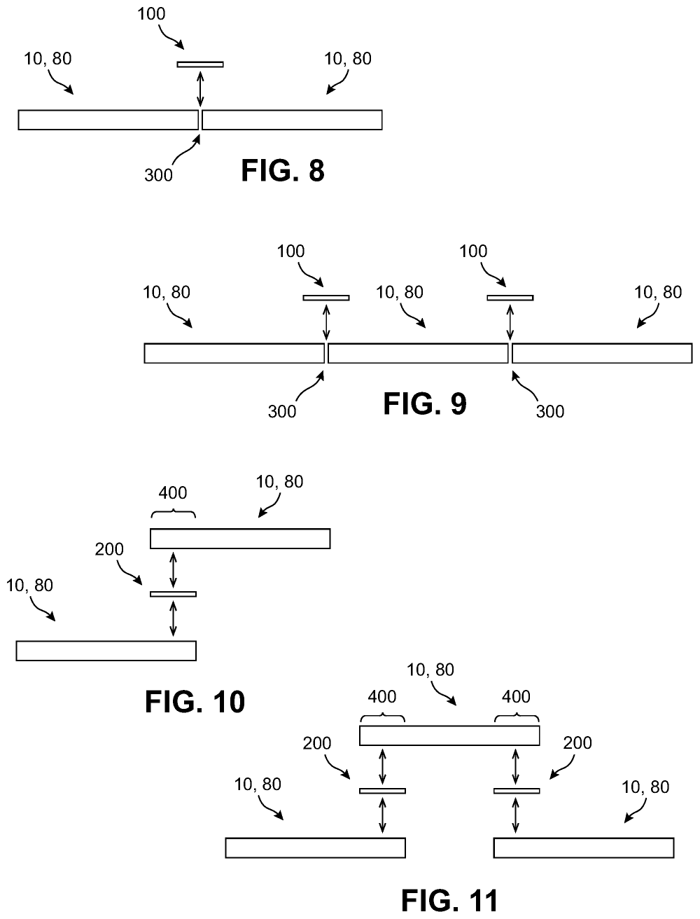

FIG. 8 illustrates the use of the single-sided tape 100 in joining two separate films 10, 80 to one another at a butt joint. A seam 300 is present between an edge of a first one of the films 10, 80 and an edge of a second one of the films 10, 80. The tape 100 is overlapped with each of the films 10, 80 over the seam 300 and is then adhered to each of the films 10, 80 to join the separate films 10, 80 to each other with the separate films 10, 80 arranged in parallel and coplanar at the seam 300. Each of the separate films 10, 80 may be representative of a panel or subpanel used to form a larger architectural structure such as a roofing structure.

FIG. 9 illustrates the use of multiple butt joints as disclosed in FIG. 8 to join three separate ones of the films 10, 80 to one another. The separate films 10, 80 include a first outer film, a second outer film, and an intermediate film disposed between the first and second outer films, wherein seams 300 are formed at each of the adjacent edges therebetween. The intermediate film may be representative of a panel or subpanel of a corresponding architectural structure in need of replacement following damage thereto. The intermediate film may accordingly be positioned between two installed films on site before application and adhesion of one of the tapes 100 over each of the seams 300 present therebetween. The intermediate film may accordingly replace a removed segment of film as a repair to a larger structure while maintaining a parallel and coplanar arrangement relative to the adjoining films.

FIG. 10 illustrates the use of the double-sided tape 200 in joining two separate films 10, 80 to one another at a lap joint. An overlap 400 is formed between an edge portion of a first one of the films 10, 80 and an edge portion of a parallel arranged second one of the films 10, 80 with the double-sided tape 200 disposed therebetween. The tape 200 is then applied to and adhered to each of the overlapping and facing surfaces of the separate films 10, 80 to form the lap joint. Each of the separate films 10, 80 may be representative of a panel or subpanel used to form a larger architectural structure such as a roofing structure.

FIG. 11 illustrates the use of multiple lap joints as disclosed in FIG. 10 to join three separate ones of the films 10, 80 to one another. The separate films 10, 80 once again include a first outer film, a second outer film, and an intermediate film disposed between the first and second outer films, wherein overlaps 400 are established between each of the adjacent edge portions of the films. The intermediate film may be representative of a panel or subpanel of a corresponding architectural structure in need of replacement following damage thereto. The intermediate film may accordingly be positioned between and partially overlapping two installed films on site before application and adhesion of one of the tapes 200 at each of the established overlaps 400. The intermediate film may accordingly replace a removed segment of film as a repair to a larger structure.

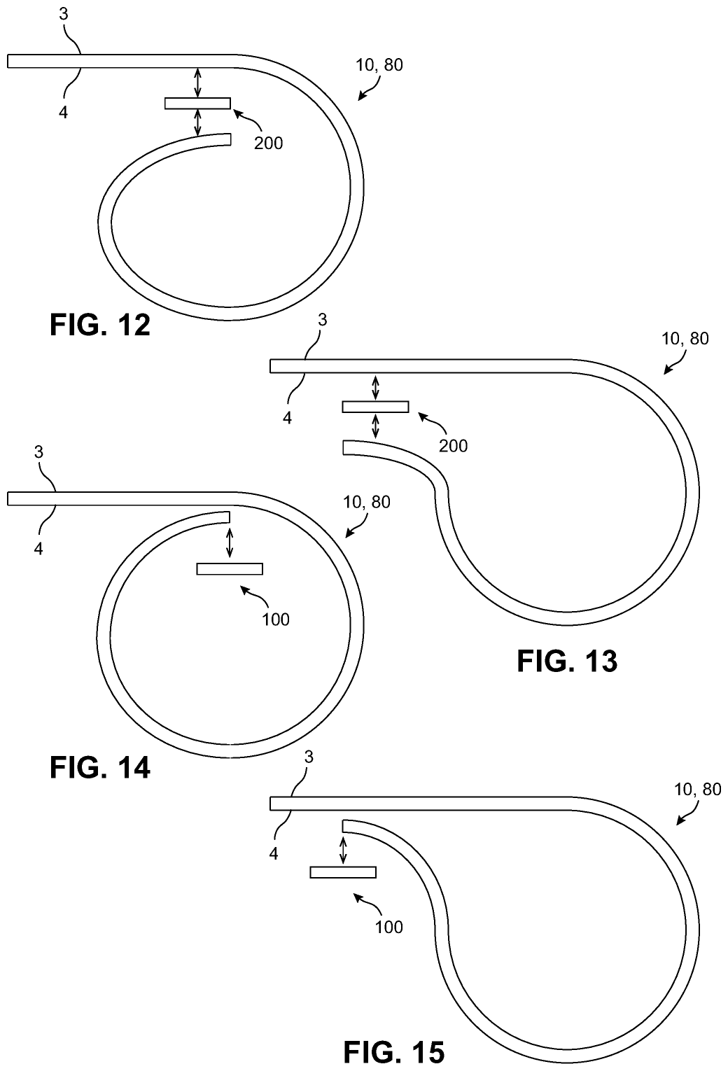

FIGS. 12-15 illustrate various different configurations for forming a cord edge along an edge portion of one of the disclosed films 10, 80. The cord edge refers to an edge feature having a loop for holding a cord or other structure therein. The cord edges may be utilized to hold cords or frame elements used to support and/or shape the panels or subpanels forming the architectural structures normally associated with the use of the films 10, 80. In each of the disclosed configurations, the corresponding film 10, 80 includes a first major surface 3 and an opposing second major surface 4 provided as outermost facing surfaces of the corresponding film 10, 80.

FIG. 12 illustrates the use of the double-sided tape 200 between an overlap provided between the first major surface 3 at an edge portion of the film 10, 80 and the second major surface 4 at a spaced apart inboard portion of the film 10, 80. The tape 200 is adhered to each of the identified portions to form the cord edge as a loop of the film 10, 80.

FIG. 13 illustrates the use of the double-sided tape 200 between an overlap provided between the second major surface 4 at an edge portion of the film 10, 80 and the second major surface 4 at a spaced apart inboard portion of the film 10, 80. The tape 200 is adhered to each of the identified portions to form the cord edge as a loop of the film 10, 80.

FIG. 14 illustrates the use of the single-sided tape 100 with the corresponding film 10, 80 looped to include the first major surface 3 at an edge portion of the film 10, 80 facing towards the second major surface 4 at a spaced apart inboard portion of the film 10, 80. The tape 100 is positioned to overlap the identified portions with the adhesive side of the tape 100 facing towards the second major surface 4 at each of the identified portions. The tape 100 is adhered to each of the identified portions to form the cord edge as a loop of the film 10, 80.

FIG. 15 illustrates the use of the single-sided tape 100 with the corresponding film 10, 80 looped to include the second major surface 4 at an edge portion of the film 10, 80 facing towards the second major surface 4 at a spaced apart inboard portion of the film 10, 80. The tape 100 is positioned to overlap the identified portions with the adhesive side of the tape 100 facing towards the first major surface 3 at the edge portion and the second major surface 4 at the inboard portion. The tape 100 is adhered to each of the identified portions to form the cord edge as a loop of the film 10, 80.

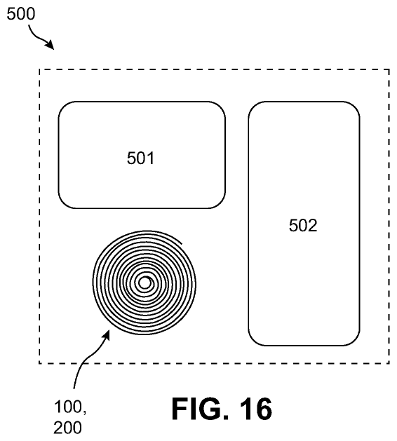

Referring now to FIG. 16, a repair kit 500 may be provided to facilitate the onsite repair or replacement of one of the panels or subpanels of films 10, 80 as shown and described herein. The kit 500 may include an activating device 501, a treating device 502, and one or more of the tapes 100, 200.

The tape 100, 200 or tapes 100, 200 included in the kit 500 may include any of the disclosed adhesives suitable for forming the desired joints, including heat activated adhesives, UV/LED activated adhesives, or PSA adhesives. The kit 500 may include only side-sided tape 100, only double-sided tape 200, combinations of single-sided tape 100 and double-sided tape 200, only one type of adhesive, multiple different types of adhesives, only one type of material forming the corresponding backing layer 110, 220, or multiple different tapes 100, 200 having differing types of materials forming the different tapes 100, 200, as desired.

The activating device 501 may be the previously mentioned heat generating device or UV/LED generating device. The kit 500 may include only one of the heat generating device or the UV/LED generating device or a combination of the two, depending on the types of tape 100, 200 included within the kit 500.

The treating device 502 may a device configured to treat a surface of the films 10, 80 in need of application of the adhesive associated with the corresponding tape 100, 200 applied thereto. The treating device 502 may be a portable corona treater or a portable plasma treater. One or both of the described treating devices 502 may be included in the kit 500.

The kit 500 may include any combination, including all or only some, of each of the components described hereinabove depending on the desired application.

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A film assembly for use in architectural applications, the film assembly comprising:
a first film having a first layer formed from a fluorinated polymer; and
a tape including a backing layer formed from a fluorinated polymer and a first adhesive layer disposed on a first major surface of the backing layer, the first adhesive layer configured to adhere to the first layer of the first film.

2. The film assembly of claim 1, wherein the fluorinated polymer forming the backing layer is one of ETFE and ECTFE.

3. The film assembly of claim 2, wherein the first layer of the first film is formed from the same material as the backing layer.

4. The film assembly of claim 1, wherein the first adhesive layer is formed from a heat activated adhesive.

5. The film assembly of claim 4, wherein the heat activated adhesive comprises at least one of Bostik LADH 7060 TM, Lumiflon® (Asahi Glass), Zeffle® (Daikin), Zendura® C100 (Honeywell), DESMODUR BL 3370 MPA (Covestro), DESMODUR BL 3475 BA/SN (Covestro), DESMODUR PL 350 MPA/SN (Covestro), DESMODUR PL340 BA/SN (Covestro), DESMODUR 3300 (Covestro), DESMODUR 3800 (Covestro), Impranil® ELH-A (Covestro), Silmer OHT (Siltech), Silmer NH (Siltech), Silmer NCO (Siltech), Silmer ACR (Siltech), Silmer OH ACR (Siltech), Silmer EP (Siltech), or Terathane (Terathane).

6. The film assembly of claim 1, wherein the first adhesive layer is formed from a UV/LED activated adhesive.

7. The film assembly of claim 1, wherein the first film is a multilayer composite film comprising the first layer, a structural polymer layer, and a second layer formed from a fluorinated polymer.

8. The film assembly of claim 7, wherein the first layer is formed from one of ETFE or ECTFE, the structural polymer layer is formed from PET, and the second layer is formed from the same material as the first layer.

9. The film assembly of claim 1, further comprising a second film having a first layer and a second adhesive layer disposed on a second major surface of the backing layer, the second adhesive layer configured adhere to the first layer of the second film to join the first film to the second film.

10. The film assembly of claim 9, wherein the first layer of the first film and the first layer of the second film are formed from the same material.

11. The film assembly of claim 1, wherein a thickness of the first film and a thickness of the backing layer are equal.

12. A method of joining components in architectural applications, the method comprising:
providing a first film having a first layer formed from a fluorinated polymer;
providing a tape including a backing layer formed from a fluorinated polymer and a first adhesive layer disposed on a first major surface of the backing layer; and
adhering the first adhesive layer of the tape to the first layer of the first film.

13. The method of claim 12, wherein the tape is disposed over a tear or puncture formed in the first layer of the first film.

14. The method of claim 12, further including providing a second film having a first layer formed from a fluorinated polymer.

15. The method of claim 14, wherein the first adhesive layer of the tape is also adhered to the first layer of the second film to couple the first film to the second film.

16. The method of claim 14, wherein the tape further includes a second adhesive layer disposed on a second major surface of the backing layer, and wherein the second adhesive layer is adhered to the first layer of the second film to couple the first film to the second film.

17. The method of claim 12, wherein the first film is a multilayer composite film comprising the first layer, a structural polymer layer, and a second layer formed from a fluorinated polymer.

18. The method of claim 12, wherein the first adhesive layer is a heat activated adhesive, and wherein the adhering step includes applying heat to the first adhesive layer.

19. The method of claim 12, wherein the first adhesive layer is a UV/LED activated adhesive, and wherein the adhering step includes applying light to the first adhesive layer.

20. A repair kit for use in architectural applications comprising:
a tape including a backing layer formed from a fluorinated polymer and a first adhesive layer disposed on a first major surface of the backing layer;
an activating device configured to activate an adhesive forming the first adhesive layer of the tape; and
a treating device configured to treat a surface to which the first adhesive layer is configured to be adhered.
